(19) United States
(12) Patent Application Publication
(10) Pub. No.: US 2007/0210005 A1
(43) Pub. Date: Sep. 13, 2007

(54) Concentrate method of ion-exchanging aluminosilicates and use in phosphate and oxyanion adsorption

(75) Inventors: Mingming Fang, Naperville, IL (US); Bala Nathan, Wheaton, IL (US); Jason St. Onge, Geneva, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AMCOL International Corporation, Arlington Heights, IL (US)

(21) Appl. No.: 11/372,297

(22) Filed: Mar. 9, 2006

(51) Int. Cl. C02F 1/42

(52) U.S. Cl. 210/683

(57) ABSTRACT

It has been found that phosphorous-containing and oxyanion compounds can be removed efficiently and economically by adsorption with cation-exchanged aluminosilicates that are ion-exchanged in a concentrated aluminosilicate composition containing the aluminosilicate, the exchange cations, and only about 15% to about 50% by weight water, based on the total weight of the aluminosilicate and water. Further, the ion-exchange process described herein has been found to be effective, in addition to those complexing or ion-exchange elements described in the Douglas '383 patent, when complexed or ion-exchanged with one or more elements of Group VIII (Fe, Co, Mi, Ru, Rh, Pd, Re, Os, Ir), Group IB (Cn, Ag, Au), and Group IIB (Zn, Cl, Hg).

### FIELD OF THE INVENTION

The present invention is directed to a concentrated method of ion-exchanging aluminosilicates, e.g., smectite clays and the use of the ion-exchanged aluminosilicate for removing phosphates and oxyanions, particularly phosphates, from contaminated matter, such as waterway sediments.

### BACKGROUND AND PRIOR ART

Douglas U.S. Pat. No. 6,350,383 B1 describes an ion-exchanged expandable clay such as saponite, bentonite or vermiculite ion-exchanged with a complexing element selected from Group IIIB and Group IVB elements, or a lanthanide to render the aluminosilicate adsorptive to oxyanions or phosphorus containing pollutants. The process of ion-exchanging the aluminosilicate with an element from Group IIIB, IVB, or lanthanum is achieved by providing a large excess of the exchange cations in solution in a weight ratio of about 100 parts of exchange cation per part by weight of the aluminosilicate.

Lanthanum was found to be thermodynamically and kinetically favorable for phosphate and arsenate ion removal because it forms insoluble salts with a very small Kₛₚ. Different solids were used to carry the lanthanum, such as a lanthanum-impregnated silica gel, and it uses found that the adsorption of phosphates reaches a maximum at a pH of 6. La³⁺- and Y³⁺-impregnated alumina also were used to remove hazardous anions, such as phosphates, from aqueous solutions. The pH, dosage of the ions, and adsorption kinetics were studied and the removal selectivity by impregnated alumina was in the order of fluoride>phosphate>arsenate>selenite. It was also found that using both soluble and insoluble lanthanum salts, such as lanthanum carboxylates, loaded on a pool filter, can remove the dissolved phosphate from the bulk of pool water.

### SUMMARY

It has been found that phosphorous-containing and oxyanion compounds can be removed efficiently and economically by adsorption with cation-exchanged aluminosilicates that are ion-exchanged in a concentrated aluminosilicate composition containing the aluminosilicate, the exchange cations, and only about 15% to about 50% by weight water, based on the total weight of the aluminosilicate and water.

As disclosed in Douglas U.S. Pat. No. 6,350,381, hereby incorporated by reference in all respects except the ion-exchange process, the water-soluble cation-containing compound is dissolved in water to form a large excess of cations, and in a ratio of dissolved cation and water to aluminosilicate of about 100:1. Thus, for each pound of ion-exchanged aluminosilicate produced, about 2.45 pounds of LaCl₃ was required and about 100 pounds of water had to be removed, making the process extremely inefficient.

The ion-exchange process described herein unexpectedly provides an ion-exchanged aluminosilicate that has about the same degree of adsorption of phosphorous-containing and oxyanion compounds, particularly phosphates. It has been found that in the process described herein is extremely less costly and time-consuming to produce phosphorous-containing and oxyanion adsorptive aluminosilicates by ion-exchanging via mixing in a concentrated aluminosilicate composition containing only about 15% to about 50% water, based on the total weight of the aluminosilicate-containing ion-exchange composition. Further, the ion-exchange process described herein has been found to be effective, in addition to those complexing or ion-exchange elements described in the Douglas '383 patent, when complexed or ion-exchanged with one or more elements of Group VIII (Fe, Co, Ni, Ru, Rh, Pd, Re, Os, Ir, Pt), Group IB (Cu, Ag, Au), and Group IIB (Zn, Cd, Hg).

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

### DETAILED DESCRIPTION

The ion-exchanged aluminosilicate adsorbents described herein are useful for contact and adsorption of oxyanion or phosphorous-containing pollutants from aqueous solutions.

Typical phosphorous-containing and oxyanion polluted matter may comprise sediments in waterways and catchments, effluent from sewage treatment plants (commercial and/or domestic), industry, aquaculture (commercial and/or domestic and/or agricultural), sediments in water supply impoundments (lakes, reservoirs), sediments in constructed wetlands and stormwater detention basins or similar engineered or natural impoundments.

Typical pollutants envisaged include phosphorus-containing compounds, anions generally which are capable of forming complexes, and in particular oxyanions such as in particular phosphates, but also arsenate, vanadate, chromate and selenate, tungstate, niobate, tantalite, and tellurate, amongst others, and peroxyanions such as persulphates. It is also expected that the adsorbents described herein may have application in removing pollutants such as organic chemical contaminants such as pesticides or herbicides or trace elements.

Typical oxyanions that can be removed from contaminated matter by the concentrated ion-exchange process described herein include, but are not limited to B₄O₇²⁻; AsO₄³⁻; SeO₄²⁻; TeO₄²⁻; VO₄³⁻; CrO₄²⁻; MoO₄²⁻; WO₄²⁻; MnO₄⁻; and mixtures of any two or more of the foregoing.

Generally, phosphorus will be removed as dissolved phosphates or orthophosphates. Phosphates exist as different species, depending upon pH and other solution physico-chemical parameters. Phosphorus is often present in polluted aqueous environments in insoluble forms, and is transformed to soluble phosphate species by various processes that can occur within the environment. Examples of insoluble phosphorus include organically-bound phosphate which may become water soluble due to biogeochemical processes, or phosphorus held in inorganic forms such as in mineral form as in mineral apatite or fertilizer, or that are bound to crystalline and/or amorphous Fe—Mn-oxyhydroxide species all of which may be released due to various biogeochemical processes.

The method may include in addition, adding a water soluble salt of the complexing element selected from lanthanides; Group IB; IIB; IIIB; IVB and Group VIII elements, along with the ion-exchangeable aluminosilicates. This would be expected to give rise to an immediate reduction in pollutant levels due to formation of complexes with the soluble salt, leaving the remediation material for more long term reduction in pollutants.

Preferably the salt is a chloride salt or a nitrate salt or a mixture of chloride and nitrate salts of the complexing element.

In accordance with the methods and adsorbent products described herein, the adsorbents are ion-exchanged aluminosilicates that are useful in reducing oxyanion and/or phosphorus pollutant loadings in matter, particularly aluminosilicates that have been cation-exchanged with a complexing element selected from the lanthanides, Group IB, Group IIB; Group IIIB; Group IVB; and Group VIII elements.

Aluminosilicate has the property of adsorbing certain cations and retaining these cations in an exchangeable state; i.e., they are exchangeable for other cations by treatment with such cations in aqueous solution. This property of exchange capacity is measured in terms of milliequilvalents per 100 gram of the material, or so-called CEC values. The CEC is typically measured by a methylene blue adsorption test, well known to those skilled in the art. The aluminosilicate may be any suitable aluminosilicate having a moderate to high cation exchange capacity (CEC)—a substrate having a CEC of greater than about 30 milliequivalents per 100 grams (meq/100 g) having a ‘moderate’ CEC, while a ‘high’ CEC aluminosilicate may have a CEC of greater than about 70 meq/100 g.

In the most preferred embodiment, the aluminosilicate is an expandable three dimensional aluminosilicate such as montmorillonite or smectite, saponite, bentonite or vermiculite. These materials are regarded as expandable clays due to their ability to absorb water of hydration into their internal lattice structure which may change the basal (d-) spacing. Other useful aluminosilicates include attapulgite, sepiolite, polygorsite and zeolites.

The aluminosilicate preferably has a high CEC to provide a high ion-exchange capacity.

The aluminosilicate may be pre-treated with a concentrated acid (e.g., HCl, HNO₃, H₂SO₄, H₃PO₄) to remove a large proportion of the interlayer and/or structural cations, before being treated with the complexing element. These acid-activated aluminosilicates (including so-called bleached earth), however, represents only one alternative to prepare the ion-exchanged aluminosilicates for phosphate and/or oxyanion adsorption. A potential advantage of this technique is that there may be a degree of modification to the underlying aluminosilicate clay structure which enhances the uptake of the complexing (ion-exchange) element. These structural changes may improve the phosphate uptake capacity.

The remediation material (ion-exchanged aluminosilicate) may be applied as a dry powder, as pellets, incorporated into a geotextile, or as a wet slurry to the surface of a waterbody, or directly to the surface of bottom sediments, or injected into the bottom sediments. It is advantageous to form a capping layer of remediation material to the surface of bottom sediments, water conditions such as flow rates and turbulence permitting. The capping layer may be of any thickness, but a range between 0.1 mm and 50 mm should prove suitable, with an optimum range between 0.5 mm and 3 mm being suitable for most conditions, without giving rise to undesirable side effects to the existing ecosystems. The layer thickness required will depend on factors such as rate, duration, and variability of phosphorus or oxyanion release, the rate and/or capacity of adsorption/binding/complexation of the remediation material, the desired phosphorus and/or oxyanion reduction and the influence of any other environmental and/or physico-chemical conditions.

The remediation material may be contained in a geotextile or other structure as disclosed in this assignees U.S. application, Ser. No. 10/718,128, filed Nov. 19, 2003, and Serial No. hereby incorporated by reference.

The remediation material is believed to be particularly suitable for reducing internal phosphorus loadings in bottom sediments in estuarine or freshwater systems.

In accordance with one embodiment of the ion-exchange methods and adsorbent products described herein, the ion-exchange elements are selected from the group comprising lanthanum (La), cerium (Ce), praseodymium (Pr), neodymium (Nd), samarium (Sm), europium (Eu) and yttrium (Y) or the group comprising zirconium (Zr) and hafnium (Hf), with lanthanum being the element of choice. As discussed above, it will also be appreciated that some of the remaining elements referred to above will not be preferred due to toxicity problems. The most preferred elements are selected from Group IIIB, Group IVB, and lanthanides, and have an atomic number between 21 and 72 inclusive.

With particular reference to the use of lanthanum, it has been demonstrated that lanthanum forms an extremely stable, redox-insensitive complex with phosphorous under most common environmental conditions, making the phosphorous unavailable to phytoplankton in aquatic systems and thus, potentially reducing the magnitude and/or frequency of algal blooms. With the lanthanum bound in the substrate, the lanthanum phosphate complex is effectively immobilized. In addition zirconium also forms a useful cation-exchanged modified substrate. It is believed that a mixture of cations comprising lanthanum and/or zirconium, optionally with other rare earth elements, may be used in the modified aluminosilicates.

The ion-exchanged sediment remediation material may also be altered by the addition of organic and/or inorganic ligands to the aluminosilicate and/or to the interlayer ions thereof, to alter its chemical properties for a particular application. This can form complexes with the exchanged cation in the substrate, resulting in the modified behavior in the sediment remediation material.

In accordance with another important embodiment of the ion-exchange methods and adsorbent products described herein, the ion-exchange elements are selected from the groups consisting of Group VIII: iron (Fe), cobalt (Co), nickel (Ni), ruthenium (Ru), palladium (Pd), rhenium (Re), rhodium (Rh), osmium (Os), iridium (Ir); or Group IB: copper (Cu), silver (Ag), gold (Au); or Group IIB: zinc (Zn), cadmium (Cd), mercury (Hg).

Lab Process of Making Cation-Exchanged Bentonite for Phosphate Removal:

A certain amount (e.g., 700 g) of selected bentonite powder (e.g., Alabama Calcium Bentonite, 200 mesh, 6-12% moisture content) was placed in a Morton Mixer. For Lanthanum exchange experiments, a certain amount of LaCl₃ (3 wt % to 10 wt % based on the clay) was dissolved in a certain amount of DI water. The amount of water needed was calculated to give 30% moisture of the bentonite. For example, if the moisture content of bentonite is 10%, the extra water needed is 140 g (30%×700 g-10%×700 g). After dissolving the LaCl₃ in the water, the LaCl₃ solution was added to the bentonite powder in the Morton Mixer (Lödige). The mixture was mixed in the Morton Mixer for total of 25 minutes. The material was then removed out and dried at 110° C. to 8-10% moisture. The bentonite was then ground to pass a 200 mesh screen using a Retsch Grinder (Retsch ZM100). The powder was then stored in a capped container and ready to use.

Lab Process for Measuring Phosphate Removal

The phosphate solutions were made by diluting the ICP (Inductively Coupled Argon Plasma) phosphorous 1000 ppm standard NH₄H₂PO₄ solution (purchased from Aldrich Chemicals) with DI water. Typically, a specific amount of cation-exchanged bentonite (e.g., 0.5 g) was added to 150 ml of the phosphate solution with a concentration range from 1 ppm to 100 ppm. The slurry was stirred at ambient temperature with a stir bar for a certain period of time (up to 24 hours). After the adsorption, about 25 ml of the slurry were taken at three time intervals and filtered through a SS grade 597 filter paper with pore size of 8-12 μm. The filtrate was collected and analyzed on a IRIS Intrepid Optical Emission Spectrometer (Thermo Elemental) using the wastewater 7 element program. The above process was repeated three times and the final phosphorous contents (P) measured by ICP were the average of the three tests.

Table 1 summarizes the results of phosphate removal capability of different cation-exchanged bentonite generated by the above-described method. The bentonites used are PGN (a high quality sodium bentonite) and Sandy Ridge (a high quality calcium bentonite). The metal salts used to provide dissolved ion-exchanged cations were LaCl₃, FeCl₂, ZnCl₂, and CuCl₂. The phosphate removal capability is measured in term of P wt % decreases after 24 hours of adsorption from the original 150 ml of 10 ppm NH₄H₂PO₄ solution. IMT Phoslock, a Lanthanum-exchanged bentonite product, manufactured based on the Douglas U.S. Pat. No. 6,350,383, is used as the standard for comparison.

TABLE 1
Phosphate Removal Capability of Different Cation
Exchanged Bentonites Generated by the Amcol
Method. (10 ppm NH₄H₂PO₄ solution)

| | | Used Salts/ | P wt % |
|---|---|---|---|
| | Metal salt/Dried | Calculated | Decreases |
| | Bentonite Weight | for 100% | after |
| Sample | Ratio | exchange Ratio | 24 hours |
| La-PGN, 0.5 g | 0.059 | 0.66 | 96.9% |
| La-PGN, 1.0 g | 0.059 | 0.66 | 99.5% |
| Zn-PGN, 0.5 g | 0.049 | 0.65 | 78.0% |
| Zn-PGN, 1.0 g | 0.049 | 0.65 | 98.8% |
| Zn-Sandy Ridge, 0.5 g | 0.043 | 0.66 | 60.4% |
| Zn-Sandy Ridge, 1.0 g | 0.043 | 0.66 | 96.3% |
| Fe-PGN, 0.5 g | 0.046 | 0.66 | 62.8% |
| Cu-PGN, 0.5 g | 0.049 | 0.66 | 54.2% |
| IMT Phoslock | 2.45 | >20 | 99.4% |
| Standard, 0.5 g | | | |

The results in table 1 indicate that even though some of the above-identified cation-exchanged bentonites have less phosphate removal capability compared to the IMT Phoslock material, the amount of metal cations needed in accordance with the ion-exchange process described herein are all 97% to 98% less than that in the IMT Phoslock process. If we compare the phosphate removal capability based on per unit weights of certain metal cations instead of per unit weight of bentonite, the ion-exchanged materials described herein will be much more efficient for phosphate removal.

Note: for a typical Sandy Ridge bentonite (8% moisture, CEC=96 meq/100 g), it requires 7.85 wt % LaCl₃ (based on the dried clay) to fully exchange (100%) all the interlayer cations with La³⁺. That is, 7.85 wt % equals a 0.0785 LaCl₃/Bentonite Weight Ratio. IMT Phoslock requires much more LaCl₃ because it needs extra La³⁺ cations in solution for its dilute La-exchanging process. As a result, there is an extreme excess of La³⁺ cations left in the ion-exchange container. PGN is highly purified sodium bentonite (8% moisture, CEC=110 meq/100 g). It requires 8.99 wt % LaCl₃ (based on the dried clay) to fully exchange (100%) all the interlayer cation with La³⁺. That 8.99 wt % equals a 0.0899 LaCl₃/Bentonite Weight Ratio. For example, in La-PGN case, Metal salt//Dried Bentonite Weight Ratio is 0.059 and the Used Salts/Calculated for 100% exchange Ratio is 0.66. That means only 5.93 wt % (0.66×8.99 wt %) LaCl₃ (based on the dried clay) was used for the ion-exchange process. The LaCl₃ salt to the dried bentonite ratio is then 0.0593 (5.93 wt %).

In real world applications, the phosphate concentration is most likely to be less than 1 ppm. And the time required to remove the phosphate is important. Table 2 summarizes the results under these conditions. All the experimental conditions are identical, as before, except the ion concentration of phosphate solution and the adsorption time.

TABLE 2
Phosphate Removal Capability of Different
Cation Exchanged Bentonites Generated by the
Amcol Method. (1 ppm NH₄H₂PO₄ solution)

| | | Used Salts/ | P wt % |
|---|---|---|---|
| | LaCl₃/Dried | Calculated | Decreases |
| | Bentonite | for 100% | after |
| Sample | Weight Ratio | exchange Ratio | 1 hour |
| La-Sandy Ridge, 0.5 g | 0.052 | 0.66 | 100% |
| La-Sandy Ridge, 0.5 g | 0.026 | 0.33 | 100% |
| Zn-Sandy Ridge, 0.5 g | 0.043 | 0.66 | 100% |
| IMT Phoslock | 2.45 | >20 | 100% |
| Standard, 0.5 g | | | |

The results in table 2 show that comparable materials and the adsorbents that are ion-exchanged as described herein remove 100% of the phosphate (ICP detection limit of P is 0.1 ppm) when the original phosphate concentration is 1 ppm within 1 hour. Even when the LaCl₃ to bentonite ratio is reduced 50% (from 0.06 to 0.03), the La-exchanged bentonite that has been ion-exchanged from a concentrated solution, as described herein, is still capable of removing 100% of the phosphate in one hour.

To further compare the phosphate removing capability between IMT Phoslock and the adsorbents that are ion-exchanged as described herein, several dry-processed materials using Sandy Ridge calcium bentonite were prepared in the lab using the Morton Mixer, as described above, and tested in 25 ppm NH₄H₂PO₄ solution. The results were summarized in Table 3.

TABLE 3
Phosphate Removal Capability of LaCl₃ exchanged Sandy Ridge Clay
by the Amcol Method. (25 ppm NH₄H₂PO₄ solution)

| | | Used Salts/ | P wt % |
|---|---|---|---|
| | LaCl₃/Dried | Calculated | Decreases |
| | Bentonite | for 100% | after |
| Sample | Weight Ratio | exchange Ratio | 10 min |
| La-Sandy Ridge, 0.5 g | 0.026 | 0.33 | 32.2 |
| La-Sandy Ridge, 0.5 g | 0.036 | 0.46 | 70.1 |
| La-Sandy Ridge, 0.5 g | 0.047 | 0.59 | 83.0 |
| IMT Phoslock | 2.45 | >20 | 92.7 |
| Standard, 0.5 g | | | |

The results in Table 3 indicate that comparable materials made by the concentrated ion-exchange method described herein are about equal to the performance of the IMT Phoslock material when a significantly higher quantity of LaCl₃ cations are used.

Plant IMT Phoslock Trial

Since lab tests found that comparable materials could be made by a dry process, a plant trial was conducted in one of the assignee's commercial plants. The type of reactor for reacting Lanthanum Chloride with sodium or calcium bentonite can be any one of the following, namely, a single screw extruder, a twin screw extruder (TSE), a pin mixer, a mixer extruder or a low pressure extruder. Among the mixer extruders, the choices could be a sigma blade mixer extruder, a pug mill extruder or other similar devices. Single screw extruder can be both the conventional full flighted equipment with an end die plate or a cut flighted screw with both internal and external die late such as the Extrudo-Mix. In this study a low pressure twin shafted mixer extruder, namely a Readco Compounder was used. This machine has co-rotating intermingling twin shafts with various types of kneading blocks. The kneading blocks can be conveying, neutral or reverse types. In the present configuration, most elements were either conveying or neutral with one set of reverse elements closer to the machine discharge. The clearances between the kneading blocks in the two shafts and between the kneading blocks and the wall for this type of extruder is significantly higher than for the conventional TSE. Also the kneading blocks themselves are larger in size compared to an equal throughput TSE. The Readco is also capable of injecting liquids at various points along its length and is jacketed for either heating or cooling during compounding.

In this study, the Sandy Ridge calcium montmonillonite clay was fed at the start of the machine near the drive end. The Lanthanum Chloride solution was injected into the barrel immediately after the clay feed and the water was injected into the barrel immediately after the Lanthanum Chloride. The Lanthanum Chloride solution injection rate was based on the clay feed rate can be varied based on the Cation exchange in the clay. The water rate was controlled to achieve the desired compounding efficiency. To help the reaction kinetics, hot water at 50-60° C. was circulated in the jacket of the extruder. The water rate was adjusted to achieve a product temperature of approx 77° C. (65-85° C.). This assured adequate power input to the product which approximated 40 KWH per ton (30-45 KWH/ton).

The Lanthanum Chloride solution and water were metered accurately to assure recipe integrity. The clay was fed from a loss-in-weight feeder, such as Accurate. Other types of feeders such as K-Tron, Brabender, Acrisson etc. would also have worked equally well.

The product from the compounder was dried on a belt dryer (also referred to as Band Dryer, Tunnel Dryer, or the like.). Other types of dryers such as Fluid bed, rotary, and the like would have worked equally well. So also, batch oven dryers would have worked as well. The product moisture was held to approximately 8% by weight. The dried product was milled using a Fitz mill and screened in a Sweco type screener. Other types of mills, such as Hammer mill, roll mill, roller mill, cage mill, or the like would have worked equally well. Other types of screeners such as Rotex, Kason, Minox Elcan, Midwest Screeners or the like should work equally well.

Using the Readco mixer and the process described above, five batches of ion-exchanged aluminosilicates were produced during this trial. Table 4 listed these five batches of materials.

TABLE 4
Phoslock Produced using Amcol's dry process at Aberdeen

| | LaCl₃/Dried | Total Moisture | | Extruder Screw | Extruder | Materials |
|---|---|---|---|---|---|---|
| | Bentonite | inside | Clay Feed | Rotation Speed | Power Output | Produced |
| Batch | Weight Ratio | Extruder % | Rate (lb/hr) | (rpm) | (hp) | (lb) |
| 1 | 0.052 | 30 | 600 | 300 | 22.4 | 510 |
| 2 | 0.052 | 30 | 1000 | 300 | 29.1 | 631 |
| 3 | 0.052 | 35 | 1000 | 300 | 23.4 | 700 |
| 4 | 0.068 | 30 | 1000 | 300 | 32.2 | 630 |
| 5 | 0.036 | 30 | 1000 | 300 | 28.0 | 670 |

* based on the weight of bentonite, ion-exchange compound, and water total

The performance of phosphate removal for these five materials produced in plant was tested and the results are listed in Table 5.

TABLE 5
Phosphate Removal Capability of LaCl₃ exchanged Sandy Ridge Clay
Generated by the Amcol Method. (1 ppm NH₄H₂PO₄ solution)

| | | Used Salts/ | P wt % |
|---|---|---|---|
| | LaCl₃/Dried | Calculated | Decreases |
| | Bentonite | for 100% | after |
| Sample | Weight Ratio | exchange Ratio | 10 min |
| Lab Sample, 0.5 g | 0.026 | 0.33 | 98.1 |
| Lab Sample, 0.5 g | 0.036 | 0.46 | 100 |
| Lab Sample, 0.5 g | 0.047 | 0.59 | 98.2 |
| Aberdeen Batch 1, 0.5 g | 0.052 | 0.66 | 100 |
| Aberdeen Batch 2, 0.5 g | 0.052 | 0.66 | 98.2 |
| Aberdeen Batch 3, 0.5 g | 0.052 | 0.66 | 98.3 |
| Aberdeen Batch 4, 0.5 g | 0.068 | 0.86 | 99.4 |
| Aberdeen Batch 5, 0.5 g | 0.036 | 0.46 | 99.5 |
| IMT Phoslock Standard, | 2.45 | >20 | 100 |
| 0.5 g | | | |

All the batches produced in the commercial plant and the IMT Phoslock materials made in the lab show efficient phosphate removal capability. After 10 min, almost all the phosphate ions were removed.

1. A method of adsorbing phosphorous-containing or oxyanion pollutants onto an ion-exchanged aluminosilicate comprising contacting said pollutants with the ion-exchanged aluminosilicate, wherein the aluminosilicate has been ion-exchanged by intimately mixing the aluminosilicate with water having a dissolved complexing element contained therein, wherein the water content is in the range of about 15% to about 50% by weight, based on the total weight of aluminosilicate and water, and wherein the complexing element is selected from the group consisting of lanthanides, Group IB, IIB, IIIB, IVB, VIII, and mixtures thereof.

2. The method of claim 1, wherein the complexing element is selected from the group consisting of Group IB, IIB, VIII, and mixtures thereof.

3. The method claim 2, wherein the complexing element is selected from the group consisting of iron (Fe), cobalt (Co), nickel (Ni), zinc (Zn), and mixtures thereof.

4. The method of claim 1, wherein the complexing element is present in contact with the aluminosilicate during ion-exchange in an amount no more than about 10% in excess of the ion-exchange capacity of the aluminosilicate.

5. The method of claim 1, wherein the aluminosilicate is selected from the group consisting of montmorillonite, smectite, beidelite, nontronite, saponite, bentonite, attapulgite, sepiolite, hectorite, vermiculite, palygorskite, zeolite and mixtures thereof.

6. The method of claim 4, wherein the aluminosilicate is acid-activated by treatment with an acid selected from the group consisting of HCl, HNO₃, H₂SO₄, H₃PO₄ and mixtures thereof.

7. The method of claim 1, wherein the complexing element is dissolved from a water-soluble salt of the complexing element.

8. The method of claim 7, wherein the water-soluble salt is a chloride salt, a nitrate salt, or a mixture of chloride and nitrate salts of the complexing element.

9. A method as claimed in claim 1 wherein the ion-exchanged aluminosilicate is applied as a dry powder, as pellets, as a granular material, or as a wet slurry to the surface of a water body.

10. A method as claimed in claim 1, wherein the ion-exchanged aluminosilicate is applied directly to a surface of bottom sediments of a water body.

11. A method as claimed in claim 1, wherein the ion-exchanged aluminosilicate is applied directly to a surface of a water body.

12. A method as claimed in claim 1, wherein the ion-exchanged aluminosilicate is applied beneath a surface of a water body and above a surface of bottom sediments of the water body.

13. A method as claimed in claim 1 wherein the ion-exchanged aluminosilicate is injected into bottom sediments of a water body.

14. A method as claimed in claim 1 wherein the ion-exchanged aluminosilicate forms a capping layer over the surface of bottom sediments of the water body.

15. A method as claimed in claim 14 wherein the capping layer has thickness between 0.1 mm and 50 mm.

16. A method as claimed in claim 1 wherein the ion-exchanged aluminosilicate is sandwiched between geotextile layers.

17. A method as claimed in claim 1, wherein the aluminosilicate has a cation exchange capacity (CEC) of greater than about 30 milliequivalents per 100 grams (Meq/100 g).

18. A method as claimed in claim 17 wherein the aluminosilicate has a cation exchange capacity (CEC) of greater than about 70 meq/100 g.

19. A method as claimed in claim 1, wherein the water content is in the range of 20-40% by weight during ion-exchange.

20. A method as claimed in claim 19, wherein the water content is in the range of 25-35% by weight during ion-exchange.

21. A method as claimed in claim 20, wherein the water content is in the range of 30-35% by weight during ion-exchange.

22. A method as claimed in claim 1, wherein intimate mixing during ion-exchange is achieved in an apparatus selected from the group consisting of an extruder, a pug mill, a pin mixer, and a mixer extruder.

23. A method as claimed in claim 1, wherein the weight ratio of the weight of the compound dissolved to provide the dissolved complexing element to the weight of the aluminosilicate, during ion-exchange, is less than 1.0.

24. A method as claimed in claim 23, wherein the weight ratio of the weight of complexing compound dissolved in water to the weight of the aluminosilicate, during ion-exchange, is less than 0.5.

25. A method as claimed in claim 24, wherein the weight ratio of the weight of complexing compound dissolved in water to the weight of the aluminosilicate, during ion-exchange, is less than 0.1.

26. A method as claimed in claim 25, wherein the weight ratio of the weight of complexing compound dissolved in water to the weight of the aluminosilicate, during ion-exchange, is in the range of 0.02 to 0.06.
